(19) United States
(12) Patent Application Publication
(10) Pub. No.: US 2025/0234182 A1
(43) Pub. Date: Jul. 17, 2025

(54) ASSOCIATION PROCEDURES FOR SEAMLESS ROAMING IN WIRELESS NETWORKS

(71) Applicant: Samsung Electronics Co., Ltd., Suwon-si (KR)

(72) Inventors: Peshal Nayak, Plano, TX (US); Boon Loong Ng, Plano, TX (US); Rubayet Shafin, Allen, TX (US); Vishnu Vardhan Ratnam, Frisco, TX (US); Yue Qi, Plano, TX (US)

(21) Appl. No.: 19/011,426

(22) Filed: Jan. 6, 2025

Related U.S. Application Data
(60) Provisional application No. 63/621,389, filed on Jan. 16, 2024.
(60) Provisional application No. 63/723,905, filed on Nov. 22, 2024.

(51) Int. Cl. H04W 8/14

(52) U.S. Cl. CPC H04W 8/14

(57) ABSTRACT

Embodiments in accordance with this disclosure provide for a station to associate with a seamless roaming domain by transmitting a message that indicates an intent to associate with the seamless roaming domain, whereby an AP affiliated with the seamless roaming domain may transmit a confirmation of the association upon which the station may seamlessly roam between APs affiliated with the seamless roaming domain.

### CROSS-REFERENCE TO RELATED APPLICATION(S)

This application claims the benefit of priority from U.S. Provisional Application No. 63/621,389, entitled “Association Procedures for Next Generation WLANS” filed Jan. 16, 2024; and U.S. Provisional Application No. 63/723,905, entitled “Association Procedures for Next Generation WLANS” filed Nov. 22, 2024, all of which are incorporated herein by reference in their entireties.

### TECHNICAL FIELD

This disclosure relates generally to a wireless communication system, and more particularly to, for example, but not limited to, association procedures for seamless roaming in wireless networks.

### BACKGROUND

Wireless local area network (WLAN) technology has evolved toward increasing data rates and continues its growth in various markets such as home, enterprise and hotspots over the years since the late 1990s. WLAN allows devices to access the internet in the 2.4 GHZ, 5 GHZ, 6 GHz or 60 GHz frequency bands. WLANs are based on the Institute of Electrical and Electronic Engineers (IEEE) 802.11 standards. IEEE 802.11 family of standards aims to increase speed and reliability and to extend the operating range of wireless networks.

WLAN devices are increasingly required to support a variety of delay-sensitive applications or real-time applications such as augmented reality (AR), robotics, artificial intelligence (AI), cloud computing, and unmanned vehicles. To implement extremely low latency and extremely high throughput required by such applications, multi-link operation (MLO) has been suggested for the WLAN. The WLAN is formed within a limited area such as a home, school, apartment, or office building by WLAN devices. Each WLAN device may have one or more stations (STAs) such as the access point (AP) STA and the non-access-point (non-AP) STA.

The MLO may enable a non-AP multi-link device (MLD) to set up multiple links with an AP MLD. Each of multiple links may enable channel access and frame exchanges between the non-AP MLD and the AP MLD independently, which may reduce latency and increase throughput.

The description set forth in the background section should not be assumed to be prior art merely because it is set forth in the background section. The background section may describe aspects or embodiments of the present disclosure.

### SUMMARY

One aspect of the present disclosure provides a station (STA) in a wireless network, comprising: a memory; and a processor coupled to the memory. The processor is configured to transmit, to an access point (AP) affiliated with a seamless roaming domain, a first frame that indicates that the STA intends to associate with the seamless roaming domain, wherein the seamless roaming domain includes one or more APs affiliated with the seamless roaming domain that provides seamless roaming. The processor is configured to receive, from the AP affiliated with the seamless roaming domain, a second frame in response to the first frame that provides a confirmation of association with the seamless roaming domain.

In some embodiments, the processor is further configured to: transmit, to one or more APs that includes the AP affiliated with the seamless roaming domain, a third frame that indicates an intent to search for the seamless roaming domain; and receive, from the AP affiliated with the seamless roaming domain, a fourth frame that includes information associated with the seamless roaming domain.

In some embodiments, the second frame includes one or more security keys that are needed for encryption and are derived using parameters of the seamless roaming domain.

In some embodiments, the first frame includes an identifier for a particular AP from the one or more APs affiliated with the seamless roaming domain that the STA intends to communicate with after association.

In some embodiments, the first frame includes a capability information for seamless roaming.

In some embodiments, the first frame includes information regarding whether a security key setup during association is transferable between the AP affiliated with the seamless roaming domain to a different AP affiliated with the seamless roaming domain during roaming or that the security key needs to be re-negotiated with the different AP at the time of roam.

In some embodiments, the second frame includes information on other APs that are a part of the seamless roaming domain that the STA is able to seamlessly roam to.

In some embodiments, the second frame includes i) information related to operation parameters of the seamless roaming domain, ii) information that describes the physical (PHY) capabilities of the seamless roaming domain, iii) information that describes the media access control (MAC) capabilities of the seamless roaming domain, iv) information that describes one or more APs that are affiliated with the seamless roaming domain and are collocated, or v) information that describes one or more APs that are affiliated with the seamless roaming domain and are non-collocated.

In some embodiments, the first frame includes an indicator that indicates that the STA intends to associate with the seamless roaming domain rather than a physical AP.

One aspect of the present disclosure provides an access point (AP) in a wireless network, comprising: a memory; and a processor coupled to the memory. The processor is configured to: receive, from a station (STA), a first frame that indicates that the STA intends to associate with a seamless roaming domain with which the AP is affiliated, wherein the seamless roaming domain includes one or more APs affiliated with the seamless roaming domain that provides seamless roaming. The processor is configured to transmit, to the STA, a second frame in response to the first frame that provides a confirmation of association with the seamless roaming domain.

In some embodiments, the processor is further configured to: receive, from the STA, a third frame that indicates an intent to search for the seamless roaming domain; and transmit, to the STA, a fourth frame that includes information associated with the seamless roaming domain.

In some embodiments, the second frame includes one or more security keys that are needed for encryption and are derived using parameters of the seamless roaming domain.

In some embodiments, the first frame includes an identifier for a particular AP from the one or more APs affiliated with the seamless roaming domain that the STA intends to communicate with after association.

In some embodiments, the first frame includes a capability information for seamless roaming.

In some embodiments, the first frame includes information regarding whether a security key setup during association is transferable between the AP affiliated with the seamless roaming domain to a different AP affiliated with the seamless roaming domain during roaming or that the security key needs to be re-negotiated with the different AP at the time of roam.

In some embodiments, the second frame includes information on other APs that are a part of the seamless roaming domain that the STA is able to seamlessly roam to.

In some embodiments, the second frame includes i) information related to operation parameters of the seamless roaming domain, ii) information that describes the physical (PHY) capabilities of the seamless roaming domain, iii) information that describes the media access control (MAC) capabilities of the seamless roaming domain, iv) information that describes one or more APs that are affiliated with the seamless roaming domain and are collocated, or v) information that describes one or more APs that are affiliated with the seamless roaming domain and are non-collocated.

In some embodiments, the first frame includes an indicator that indicates that the STA intends to associate with the seamless roaming domain rather than a physical AP.

One aspect of the present disclosure provides a computer-implemented method for wireless communication by a station (STA) in a wireless network. The method comprises transmitting, to an access point (AP) affiliated with a seamless roaming domain, a first frame that indicates that the STA intends to associate with the seamless roaming domain, wherein the seamless roaming domain includes one or more APs affiliated with the seamless roaming domain that provides seamless roaming. The method comprises receiving, from the AP affiliated with the seamless roaming domain, a second frame in response to the first frame that provides a confirmation of association with the seamless roaming domain.

In some embodiments, the method further comprises transmitting, to one or more APs that includes the AP affiliated with the seamless roaming domain, a third frame that indicates an intent to search for the seamless roaming domain; and receiving, from the AP affiliated with the seamless roaming domain, a fourth frame that includes information associated with the seamless roaming domain.

### BRIEF DESCRIPTION OF THE DRAWINGS

FIG. 1 illustrates an example of a wireless network in accordance with an embodiment.

FIG. 2A illustrates an example of AP in accordance with an embodiment.

FIG. 2B illustrates an example of STA in accordance with an embodiment.

FIG. 3 illustrates an example of multi-link communication operation in accordance with an embodiment.

FIG. 4 illustrates stages of a mobility handover procedure in accordance with an embodiment.

FIG. 5 illustrates a logical AP MLD in accordance with an embodiment.

FIG. 6 illustrates a seamless roaming domain that includes several APs in accordance with an embodiment.

FIG. 7 illustrates an example operation of associating with a logical AP MLD in accordance with an embodiment.

FIG. 8 illustrates an example element format for association with seamless roaming domain in accordance with an embodiment.

FIG. 9 illustrates a roaming capabilities element in accordance with an embodiment.

FIG. 10 illustrates an example of associating with a logical AP MLD in accordance with an embodiment.

FIG. 11 illustrates a flow chart of an example process performed by an STA of associating with a seamless roaming domain (SRD) in accordance with an embodiment.

In one or more implementations, not all of the depicted components in each figure may be required, and one or more implementations may include additional components not shown in a figure. Variations in the arrangement and type of the components may be made without departing from the scope of the subject disclosure. Additional components, different components, or fewer components may be utilized within the scope of the subject disclosure.

### DETAILED DESCRIPTION

The detailed description set forth below, in connection with the appended drawings, is intended as a description of various implementations and is not intended to represent the only implementations in which the subject technology may be practiced. Rather, the detailed description includes specific details for the purpose of providing a thorough understanding of the inventive subject matter. As those skilled in the art would realize, the described implementations may be modified in various ways, all without departing from the scope of the present disclosure. Accordingly, the drawings and description are to be regarded as illustrative in nature and not restrictive. Like reference numerals designate like elements.

The following description is directed to certain implementations for the purpose of describing the innovative aspects of this disclosure. However, a person having ordinary skill in the art will readily recognize that the teachings herein can be applied in a multitude of different ways. The examples in this disclosure are based on WLAN communication according to the Institute of Electrical and Electronics Engineers (IEEE) 802.11 standard, including IEEE 802.11be standard and any future amendments to the IEEE 802.11 standard. However, the described embodiments may be implemented in any device, system or network that is capable of transmitting and receiving radio frequency (RF) signals according to the IEEE 802.11 standard, the Bluetooth standard, Global System for Mobile communications (GSM), GSM/General Packet Radio Service (GPRS), Enhanced Data GSM Environment (EDGE), Terrestrial Trunked Radio (TETRA), Wideband-CDMA (W-CDMA), Evolution Data Optimized (EV-DO), 1×EV-DO, EV-DO Rev A, EV-DO Rev B, High Speed Packet Access (HSPA), High Speed Downlink Packet Access (HSDPA), High Speed Uplink Packet Access (HSUPA), Evolved High Speed Packet Access (HSPA+), Long Term Evolution (LTE), 5G NR (New Radio), AMPS, or other known signals that are used to communicate within a wireless, cellular or internet of things (IoT) network, such as a system utilizing 3G, 4G, 5G, 6G, or further implementations thereof, technology.

Depending on the network type, other well-known terms may be used instead of “access point” or “AP,” such as “router” or “gateway.” For the sake of convenience, the term “AP” is used in this disclosure to refer to network infrastructure components that provide wireless access to remote terminals. In WLAN, given that the AP also contends for the wireless channel, the AP may also be referred to as a STA. Also, depending on the network type, other well-known terms may be used instead of “station” or “STA,” such as “mobile station,” “subscriber station,” “remote terminal,” “user equipment,” “wireless terminal,” or “user device.” For the sake of convenience, the terms “station” and “STA” are used in this disclosure to refer to remote wireless equipment that wirelessly accesses an AP or contends for a wireless channel in a WLAN, whether the STA is a mobile device (such as a mobile telephone or smartphone) or is normally considered a stationary device (such as a desktop computer, AP, media player, stationary sensor, television, etc.).

Multi-link operation (MLO) is a key feature that is currently being developed by the standards body for next generation extremely high throughput (EHT) Wi-Fi systems in IEEE 802.11be. The Wi-Fi devices that support MLO are referred to as multi-link devices (MLD). With MLO, it is possible for a non-AP MLD to discover, authenticate, associate, and set up multiple links with an AP MLD. Channel access and frame exchange is possible on each link between the AP MLD and non-AP MLD.

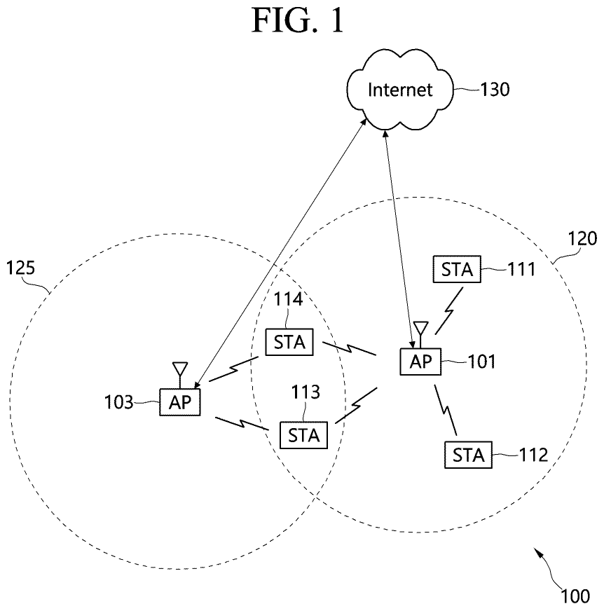

FIG. 1 shows an example of a wireless network 100 in accordance with an embodiment. The embodiment of the wireless network 100 shown in FIG. 1 is for illustrative purposes only. Other embodiments of the wireless network 100 could be used without departing from the scope of this disclosure.

As shown in FIG. 1, the wireless network 100 may include a plurality of wireless communication devices. Each wireless communication device may include one or more stations (STAs). The STA may be a logical entity that is a singly addressable instance of a medium access control (MAC) layer and a physical (PHY) layer interface to the wireless medium. The STA may be classified into an access point (AP) STA and a non-access point (non-AP) STA. The AP STA may be an entity that provides access to the distribution system service via the wireless medium for associated STAs. The non-AP STA may be a STA that is not contained within an AP-STA. For the sake of simplicity of description, an AP STA may be referred to as an AP and a non-AP STA may be referred to as a STA. In the example of FIG. 1, APs 101 and 103 are wireless communication devices, each of which may include one or more AP STAs. In such embodiments, APs 101 and 103 may be AP multi-link device (MLD). Similarly, STAs 111-114 are wireless communication devices, each of which may include one or more non-AP STAs. In such embodiments, STAs 111-114 may be non-AP MLD.

The APs 101 and 103 communicate with at least one network 130, such as the Internet, a proprietary Internet Protocol (IP) network, or other data network. The AP 101 provides wireless access to the network 130 for a plurality of stations (STAs) 111-114 with a coverage are 120 of the AP 101. The APs 101 and 103 may communicate with each other and with the STAs using Wi-Fi or other WLAN communication techniques.

Depending on the network type, other well-known terms may be used instead of “access point” or “AP,” such as “router” or “gateway.” For the sake of convenience, the term “AP” is used in this disclosure to refer to network infrastructure components that provide wireless access to remote terminals. In WLAN, given that the AP also contends for the wireless channel, the AP may also be referred to as a STA. Also, depending on the network type, other well-known terms may be used instead of “station” or “STA,” such as “mobile station,” “subscriber station,” “remote terminal,” “user equipment,” “wireless terminal,” or “user device.” For the sake of convenience, the terms “station” and “STA” are used in this disclosure to refer to remote wireless equipment that wirelessly accesses an AP or contends for a wireless channel in a WLAN, whether the STA is a mobile device (such as a mobile telephone or smartphone) or is normally considered a stationary device (such as a desktop computer, AP, media player, stationary sensor, television, etc.).

In FIG. 1, dotted lines show the approximate extents of the coverage area 120 and 125 of APs 101 and 103, which are shown as approximately circular for the purposes of illustration and explanation. It should be clearly understood that coverage areas associated with APs, such as the coverage areas 120 and 125, may have other shapes, including irregular shapes, depending on the configuration of the APs.

As described in more detail below, one or more of the APs may include circuitry and/or programming for management of MU-MIMO and OFDMA channel sounding in WLANs.

Although FIG. 1 shows one example of a wireless network 100, various changes may be made to FIG. 1. For example, the wireless network 100 could include any number of APs and any number of STAs in any suitable arrangement. Also, the AP 101 could communicate directly with any number of STAs and provide those STAs with wireless broadband access to the network 130. Similarly, each AP 101 and 103 could communicate directly with the network 130 and provides STAs with direct wireless broadband access to the network 130. Further, the APs 101 and/or 103 could provide access to other or additional external networks, such as external telephone networks or other types of data networks.

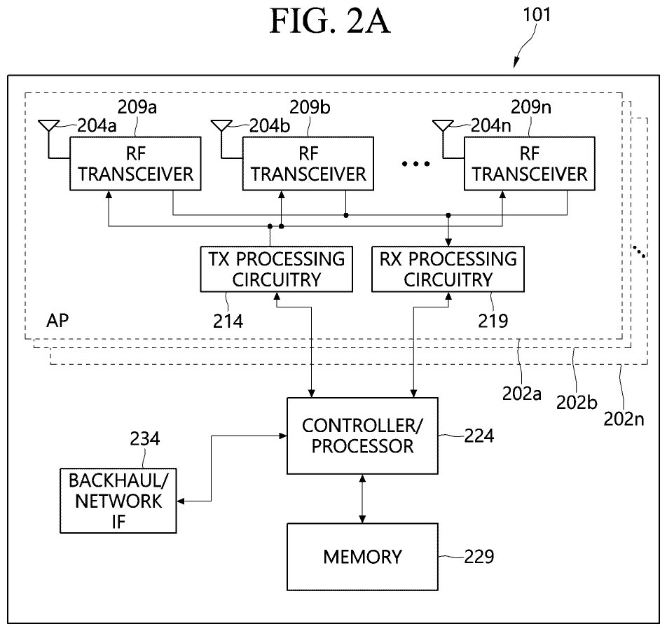

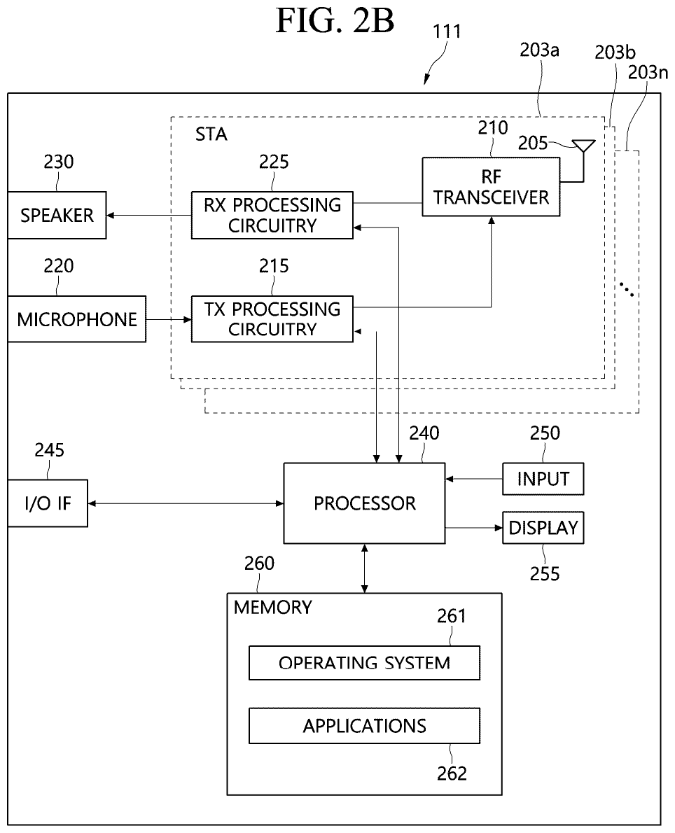

FIG. 2A shows an example of AP 101 in accordance with an embodiment. The embodiment of the AP 101 shown in FIG. 2A is for illustrative purposes, and the AP 103 of FIG. 1 could have the same or similar configuration. However, APs come in a wide range of configurations, and FIG. 2A does not limit the scope of this disclosure to any particular implementations of an AP.

As shown in FIG. 2A, the AP 101 may include multiple antennas 204a-204n, multiple radio frequency (RF) transceivers 209a-209n, transmit (TX) processing circuitry 214, and receive (RX) processing circuitry 219. The AP 101 also may include a controller/processor 224, a memory 229, and a backhaul or network interface 234. The RF transceivers 209a-209n receive, from the antennas 204a-204n, incoming RF signals, such as signals transmitted by STAs in the network 100. The RF transceivers 209a-209n down-convert the incoming RF signals to generate intermediate (IF) or baseband signals. The IF or baseband signals are sent to the RX processing circuitry 219, which generates processed baseband signals by filtering, decoding, and/or digitizing the baseband or IF signals. The RX processing circuitry 219 transmits the processed baseband signals to the controller/processor 224 for further processing.

The TX processing circuitry 214 receives analog or digital data (such as voice data, web data, e-mail, or interactive video game data) from the controller/processor 224. The TX processing circuitry 214 encodes, multiplexes, and/or digitizes the outgoing baseband data to generate processed baseband or IF signals. The RF transceivers 209a-209n receive the outgoing processed baseband or IF signals from the TX processing circuitry 214 and up-converts the baseband or IF signals to RF signals that are transmitted via the antennas 204a-204n.

The controller/processor 224 can include one or more processors or other processing devices that control the overall operation of the AP 101. For example, the controller/processor 224 could control the reception of uplink signals and the transmission of downlink signals by the RF transceivers 209a-209n, the RX processing circuitry 219, and the TX processing circuitry 214 in accordance with well-known principles. The controller/processor 224 could support additional functions as well, such as more advanced wireless communication functions. For instance, the controller/processor 224 could support beam forming or directional routing operations in which outgoing signals from multiple antennas 204a-204n are weighted differently to effectively steer the outgoing signals in a desired direction. The controller/processor 224 could also support OFDMA operations in which outgoing signals are assigned to different subsets of subcarriers for different recipients (e.g., different STAs 111-114). Any of a wide variety of other functions could be supported in the AP 101 by the controller/processor 224 including a combination of DL MU-MIMO and OFDMA in the same transmit opportunity. In some embodiments, the controller/processor 224 may include at least one microprocessor or microcontroller. The controller/processor 224 is also capable of executing programs and other processes resident in the memory 229, such as an OS. The controller/processor 224 can move data into or out of the memory 229 as required by an executing process.

The controller/processor 224 is also coupled to the backhaul or network interface 234. The backhaul or network interface 234 allows the AP 101 to communicate with other devices or systems over a backhaul connection or over a network. The interface 234 could support communications over any suitable wired or wireless connection(s). For example, the interface 234 could allow the AP 101 to communicate over a wired or wireless local area network or over a wired or wireless connection to a larger network (such as the Internet). The interface 234 may include any suitable structure supporting communications over a wired or wireless connection, such as an Ethernet or RF transceiver. The memory 229 is coupled to the controller/processor 224. Part of the memory 229 could include a RAM, and another part of the memory 229 could include a Flash memory or other ROM.

As described in more detail below, the AP 101 may include circuitry and/or programming for management of channel sounding procedures in WLANs. Although FIG. 2A illustrates one example of AP 101, various changes may be made to FIG. 2A. For example, the AP 101 could include any number of each component shown in FIG. 2A. As a particular example, an AP could include a number of interfaces 234, and the controller/processor 224 could support routing functions to route data between different network addresses. As another example, while shown as including a single instance of TX processing circuitry 214 and a single instance of RX processing circuitry 219, the AP 101 could include multiple instances of each (such as one per RF transceiver). Alternatively, only one antenna and RF transceiver path may be included, such as in legacy APs. Also, various components in FIG. 2A could be combined, further subdivided, or omitted and additional components could be added according to particular needs.

As shown in FIG. 2A, in some embodiment, the AP 101 may be an AP MLD that includes multiple APs 202a-202n. Each AP 202a-202n is affiliated with the AP MLD 101 and includes multiple antennas 204a-204n, multiple radio frequency (RF) transceivers 209a-209n, transmit (TX) processing circuitry 214, and receive (RX) processing circuitry 219. Each APs 202a-202n may independently communicate with the controller/processor 224 and other components of the AP MLD 101. FIG. 2A shows that each AP 202a-202n has separate multiple antennas, but each AP 202a-202n can share multiple antennas 204a-204n without needing separate multiple antennas. Each AP 202a-202n may represent a physical (PHY) layer and a lower media access control (MAC) layer.

FIG. 2B shows an example of STA 111 in accordance with an embodiment. The embodiment of the STA 111 shown in FIG. 2B is for illustrative purposes, and the STAs 111-114 of FIG. 1 could have the same or similar configuration. However, STAs come in a wide variety of configurations, and FIG. 2B does not limit the scope of this disclosure to any particular implementation of a STA.

As shown in FIG. 2B, the STA 111 may include antenna(s) 205, a RF transceiver 210, TX processing circuitry 215, a microphone 220, and RX processing circuitry 225. The STA 111 also may include a speaker 230, a controller/processor 240, an input/output (I/O) interface (IF) 245, a touchscreen 250, a display 255, and a memory 260. The memory 260 may include an operating system (OS) 261 and one or more applications 262.

The RF transceiver 210 receives, from the antenna(s) 205, an incoming RF signal transmitted by an AP of the network 100. The RF transceiver 210 down-converts the incoming RF signal to generate an IF or baseband signal. The IF or baseband signal is sent to the RX processing circuitry 225, which generates a processed baseband signal by filtering, decoding, and/or digitizing the baseband or IF signal. The RX processing circuitry 225 transmits the processed baseband signal to the speaker 230 (such as for voice data) or to the controller/processor 240 for further processing (such as for web browsing data).

The TX processing circuitry 215 receives analog or digital voice data from the microphone 220 or other outgoing baseband data (such as web data, e-mail, or interactive video game data) from the controller/processor 240. The TX processing circuitry 215 encodes, multiplexes, and/or digitizes the outgoing baseband data to generate a processed baseband or IF signal. The RF transceiver 210 receives the outgoing processed baseband or IF signal from the TX processing circuitry 215 and up-converts the baseband or IF signal to an RF signal that is transmitted via the antenna(s) 205.

The controller/processor 240 can include one or more processors and execute the basic OS program 261 stored in the memory 260 in order to control the overall operation of the STA 111. In one such operation, the controller/processor 240 controls the reception of downlink signals and the transmission of uplink signals by the RF transceiver 210, the RX processing circuitry 225, and the TX processing circuitry 215 in accordance with well-known principles. The controller/processor 240 can also include processing circuitry configured to provide management of channel sounding procedures in WLANs. In some embodiments, the controller/processor 240 may include at least one microprocessor or microcontroller.

The controller/processor 240 is also capable of executing other processes and programs resident in the memory 260, such as operations for management of channel sounding procedures in WLANs. The controller/processor 240 can move data into or out of the memory 260 as required by an executing process. In some embodiments, the controller/processor 240 is configured to execute a plurality of applications 262, such as applications for channel sounding, including feedback computation based on a received null data packet announcement (NDPA) and null data packet (NDP) and transmitting the beamforming feedback report in response to a trigger frame (TF). The controller/processor 240 can operate the plurality of applications 262 based on the OS program 261 or in response to a signal received from an AP. The controller/processor 240 is also coupled to the I/O interface 245, which provides STA 111 with the ability to connect to other devices such as laptop computers and handheld computers. The I/O interface 245 is the communication path between these accessories and the main controller/processor 240.

The controller/processor 240 is also coupled to the input 250 (such as touchscreen) and the display 255. The operator of the STA 111 can use the input 250 to enter data into the STA 111. The display 255 may be a liquid crystal display, light emitting diode display, or other display capable of rendering text and/or at least limited graphics, such as from web sites. The memory 260 is coupled to the controller/processor 240. Part of the memory 260 could include a random access memory (RAM), and another part of the memory 260 could include a Flash memory or other read-only memory (ROM).

Although FIG. 2B shows one example of STA 111, various changes may be made to FIG. 2B. For example, various components in FIG. 2B could be combined, further subdivided, or omitted and additional components could be added according to particular needs. In particular examples, the STA 111 may include any number of antenna(s) 205 for MIMO communication with an AP 101. In another example, the STA 111 may not include voice communication or the controller/processor 240 could be divided into multiple processors, such as one or more central processing units (CPUs) and one or more graphics processing units (GPUs). Also, while FIG. 2B illustrates the STA 111 configured as a mobile telephone or smartphone, STAs could be configured to operate as other types of mobile or stationary devices.

As shown in FIG. 2B, in some embodiment, the STA 111 may be a non-AP MLD that includes multiple STAs 203a-203n. Each STA 203a-203n is affiliated with the non-AP MLD 111 and includes an antenna(s) 205, a RF transceiver 210, TX processing circuitry 215, and RX processing circuitry 225. Each STAs 203a-203n may independently communicate with the controller/processor 240 and other components of the non-AP MLD 111. FIG. 2B shows that each STA 203a-203n has a separate antenna, but each STA 203a-203n can share the antenna 205 without needing separate antennas. Each STA 203a-203n may represent a physical (PHY) layer and a lower media access control (MAC) layer.

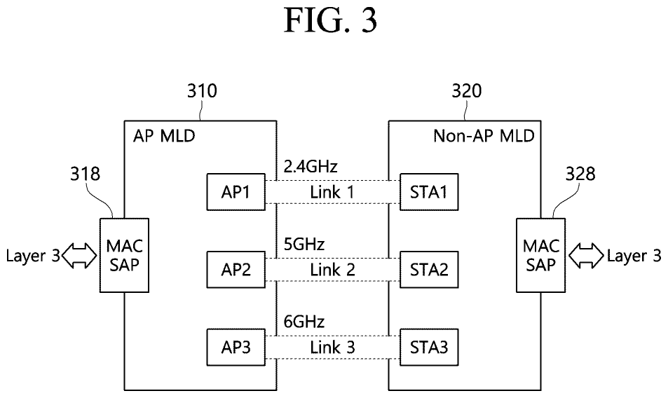

FIG. 3 shows an example of multi-link communication operation in accordance with an embodiment. The multi-link communication operation may be usable in IEEE 802.11be standard and any future amendments to IEEE 802.11 standard. In FIG. 3, an AP MLD 310 may be the wireless communication device 101 and 103 in FIG. 1 and a non-AP MLD 220 may be one of the wireless communication devices 111-114 in FIG. 1.

As shown in FIG. 3, the AP MLD 310 may include a plurality of affiliated APs, for example, including AP 1, AP 2, and AP 3. Each affiliated AP may include a PHY interface to wireless medium (Link 1, Link 2, or Link 3). The AP MLD 310 may include a single MAC service access point (SAP) 318 through which the affiliated APs of the AP MLD 310 communicate with a higher layer (Layer 3 or network layer). Each affiliated AP of the AP MLD 310 may have a MAC address (lower MAC address) different from any other affiliated APs of the AP MLD 310. The AP MLD 310 may have a MLD MAC address (upper MAC address) and the affiliated APs share the single MAC SAP 318 to Layer 3. Thus, the affiliated APs share a single IP address, and Layer 3 recognizes the AP MLD 310 by assigning the single IP address.

The non-AP MLD 320 may include a plurality of affiliated STAs, for example, including STA 1, STA 2, and STA 3. Each affiliated STA may include a PHY interface to the wireless medium (Link 1, Link 2, or Link 3). The non-AP MLD 320 may include a single MAC SAP 328 through which the affiliated STAs of the non-AP MLD 320 communicate with a higher layer (Layer 3 or network layer). Each affiliated STA of the non-AP MLD 320 may have a MAC address (lower MAC address) different from any other affiliated STAs of the non-AP MLD 320. The non-AP MLD 320 may have a MLD MAC address (upper MAC address) and the affiliated STAs share the single MAC SAP 328 to Layer 3. Thus, the affiliated STAs share a single IP address, and Layer 3 recognizes the non-AP MLD 320 by assigning the single IP address.

The AP MLD 310 and the non-AP MLD 320 may set up multiple links between their affiliate APs and STAs. In this example, the AP 1 and the STA 1 may set up Link 1 which operates in 2.4 GHz band. Similarly, the AP 2 and the STA 2 may set up Link 2 which operates in 5 GHz band, and the AP 3 and the STA 3 may set up Link 3 which operates in 6 GHz band. Each link may enable channel access and frame exchange between the AP MLD 310 and the non-AP MLD 320 independently, which may increase date throughput and reduce latency. Upon associating with an AP MLD on a set of links (setup links), each non-AP device is assigned a unique association identifier (AID).

The following documents are hereby incorporated by reference in their entirety into the present disclosure as if fully set forth herein: i) IEEE 802.11-2020, “Wireless LAN Medium Access Control (MAC) and Physical Layer (PHY) Specifications,” ii) IEEE 802.11ax-2021, “Wireless LAN Medium Access Control (MAC) and Physical Layer (PHY) Specifications,” and ii) IEEE P802.11be/D4.0, “Wireless LAN Medium Access Control (MAC) and Physical Layer (PHY) Specifications.”

As users move around an environment while holding an STA device, a signal strength of the STA to its connected AP can vary. If a user movement causes a significant decrease in a signal strength, a handover may be necessary. During the process of handover, an STA may switch from its current associated AP to a new AP.

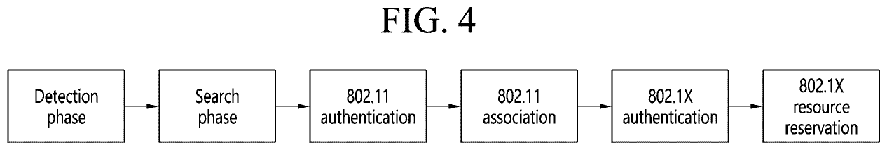

FIG. 4 illustrates stages of a mobility handover procedure in accordance with an embodiment. As shown in FIG. 4, in legacy devices without any mobility support, the handover procedure may involve several steps, including a detection phase 401, a search phase 403, an 802.11 authentication phase 405, an 802.11 association phase 407, an 802.1X authentication phase 409, and a 802.11 resource reservation phase 411.

During the detection phase 401, an STA may determine that there is a need for a handover. The procedures to detect a need for handover may be vendor specific. For instance, a particular vendor implementation can choose to trigger handover when the signal strength to the currently associated AP drops below a certain threshold.

The detection phase 401 may be followed by a search phase 403. During the search phase 403, the STA may search for new APs to associate with. During the search phase 403, the STA may perform a scan of different channels to identify APs in the vicinity. This can be done either passively, for example, by listening to beacons on a particular channel, or actively, for example, by the use of probe request and response procedure.

After the scanning procedure is complete, the next step is to perform 802.11 authentication (open system/shared key based) 405. Once the STA is authenticated, the next step is to perform 802.11 association 807. Introduced in IEEE 802.1i amendment, the 802.1X authentication phase 409 may include an EAP authentication between the STA and a AAA server with the assistance of the AP. Finally, during the 802.11 resource reservation phase 411, the STA may set up various resources at the new AP. For example, the STA can perform QoS reservation, BA setup, among other operations with the newly associated AP.

Typically, during a handover, there can be a disruption in the connection as the setup procedure operates in a break-before-make manner. This can cause an impact on user experience especially with multimedia services which can suffer from session disruptions due to the high delay encountered during handover procedure.

In order to reduce the handover delay, a number of procedures have been introduced in several standards. The focus of these procedures may be to remove or reduce the delay encountered in various steps of the handover procedure. In 2008, IEEE 802.11r standard introduced a fast transition roaming which may eliminate the need for the authentication step during the handover. In 2011, IEEE 802.11k introduced assisted roaming which reduces the search phase by allowing the STA to request the AP to send channel information of candidate neighbor APs. In 2011, IEEE 802.11v also introduced network assisted roaming to assist the search phase. In IEEE 802.11be, the fast BSS transition procedure was extended to cover the case of MLO operation. This procedure helps to reduce the delays encountered due to 802.11 resource reservation. However, the STA may still need to perform the association and authentication phases which can take a period of time e.g., tens of milliseconds.

In next generation WLANs, low-latency with high reliability support has been targeted. In order to meet this goal, the concept of a logical AP MLD can be considered.

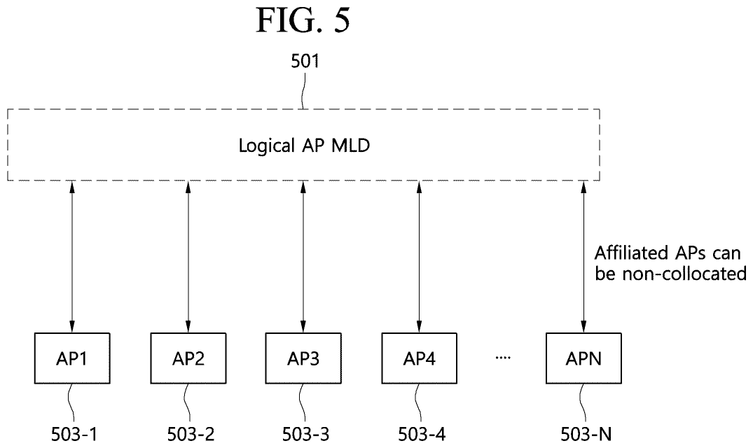

FIG. 5 illustrates a logical AP MLD in accordance with an embodiment. As illustrated in FIG. 5, a logical AP MLD 501 can be made up of several APs, including AP1 503-1, AP2 503-2, AP3 503-3, AP4 503-4 to APN 503-N, which can be non-collocated. This may be different from the concept of AP MLD in IEEE 802.11be which considers collocated APs affiliated with an AP MLD. Further, one or more of these APs can have a common data path to a router or a central controller. The APs 503-1 to 503-N shown in FIG. 5 can form a logical AP MLD 501. This concept of AP MLD may reduce the delays of association and authentication steps mentioned above as the STA may not need to perform association and authentication during handover.

A logical AP MLD can also be used for a number of purposes including mobility management, multi-AP coordination, relay operations, among others. As described herein, the term logical AP MLD may refer to a coordination that may be established between APs to achieve a seamless roaming (e.g., seamless roaming domain, enhancement to baseline FT procedures, non-collocated AP MLD, among others).

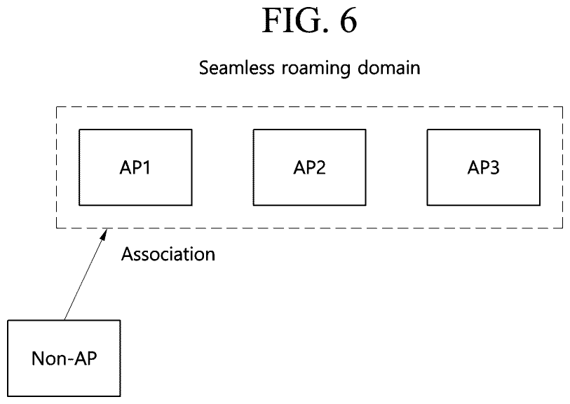

Embodiments in accordance with this disclosure provide procedures for association with a logical AP MLD. Current procedures allow an association with a physical AP MLD, however, lack support for logical AP MLD association. As illustrated in FIG. 6, a seamless roaming domain includes AP1, AP2, and AP3. The non-AP STA is associated with only AP1, and not with the seamless roaming domain. Accordingly, embodiments in accordance with this disclosure enable a non-AP MLD to associate with a logical AP MLD.

In some embodiments, a non-AP MLD can make an indication during a search or association phase that it intends to associate with a logical AP MLD instead of a physical AP MLD. The indication can be made in an indication message transmitted by the non-AP MLD. The indication message can include at least one or more of the information items as indicated in Table 1.

TABLE 1

| Information item | Description |
|---|---|
| Non-AP MLD | An information item that can identify the non-AP MLD that is making the |
| indicator | request. e.g., non-AP MLD MAC address. |
| Logical AP | An information item that can indicate the non-AP MLD's intent to |
| association | associate with a logical AP MLD. Example indicators can be as shown in |
| indicator | Table 2. |
| Physical AP/AP | One or more information items that can indicate the physical AP/AP |
| MLD identifier | MLD that the non-AP can communicate with after association. e.g., a |
| | MAC address, MLD ID, new ID, link ID(s), among others. |
| Seamless | One or more information items that can indicate the seamless roaming |
| roaming related | related capabilities from the non-AP. e.g., PHY capabilities, MAC |
| capabilities | capabilities, near static context transfer related capabilities, dynamic |
| from the STA | context transfer related capabilities, roaming preparation stage related |
| | capabilities, roaming setup stage related capabilities, roaming transition |
| | stage related capabilities, among others. |
| Security key | One or more information items that can indicate if security keys setup |
| related | during association can be transferred during roaming or need to be |
| capabilities/ | rekeyed/renegotiated at the time of roam. |
| constraints | |

The above information items can be transmitted together or separately. They can be transmitted as a part of any existing frame/element/field/subfield in the standard or can be a part of newly defined ones.

Examples of logical AP MLD association indicators in accordance with some embodiments are shown in Table 2.

TABLE 2

| Information item | Description |
|---|---|
| Indicator bit | A bit that can take a predetermined value (e.g., 1) to indicate an intent to |
| | associate with a logical AP MLD. The bit can also take another |
| | predetermined value (e.g., 0) to indicate an intent to not associate with a |
| | logical AP MLD or to associate with the physical AP MLD. |
| Indicator flag | A flag that can take a predetermined value (e.g., 1) to indicate an intent to |
| | associate with a logical AP MLD. The flag can also take another |
| | predetermined value (e.g., 0) to indicate an intent to not associate with a |
| | logical AP MLD or to associate with the physical AP MLD. |
| Reason code | A reason code that can indicate that the reason for sending the message is to |
| | associate with the logical AP MLD instead of the physical AP MLD. |
| Bit based | An encoding wherein multiple bits are set to a specific value/pattern to |
| encoding | indicate the intent to associate with a logical AP MLD. |
| Implicit | An implicit indication can be made by including or initiation one or more |
| indication | signaling that are related to logical AP MLD operation. e.g., including an |
| | information element that is used for logical AP MLD operation. |
| Logical AP | An identifier for the set of APs that form the logical AP MLD. e.g., an ID, a |
| MLD | MAC address, among others. |
| identifier | |

The above information items can be transmitted together or separately. They can be transmitted as a part of any existing frame/element/field/subfield in the standard or can be a part of newly defined ones.

In some embodiments, when the indication message is received, the receiver can interpret the message as an indicator of the non-AP MLD's intent to associate with the logical AP MLD. Thereafter, if the receiver is the AP MLD, it can enable the non-AP MLD's association with the logical AP MLD if the non-AP MLD has made the indication. If the non-AP MLD has not made such an indication, then the AP MLD can enable the non-AP MLD to associate with the physical AP MLD instead. This can require the non-AP to use baseline roaming procedures or some other roaming enhancement when roaming from one AP MLD to another.

In some embodiments, the AP MLD can then transmit a confirmation or response message that can confirm or provide the status of the association with a logical AP MLD instead of the physical AP MLD. The AP MLD's confirm message can include at least one or more of the information items as indicated in Table 3.

TABLE 3

| Information item | Description |
|---|---|
| Indicator bit | A bit that can take a predetermined value (e.g., 1) to confirm the association |
| | with a logical AP MLD. The bit can also take another predetermined value |
| | (e.g., 0) to confirm the intent to not associate with a logical AP MLD or to |
| | associate with the physical AP MLD. |
| Indicator flag | A flag that can take a predetermined value (e.g., 1) to confirm the intent to |
| | associate with a logical AP MLD. The flag can also take another |
| | predetermined value (e.g., 0) to confirm the intent to not associate with a |
| | logical AP MLD or to associate with the physical AP MLD. |
| Reason code | A reason code that can indicate that the reason for sending the message is to |
| | confirm the intent to associate with the logical AP MLD instead of the |
| | physical AP MLD. |
| Status code | A status code that can indicate that the status of the request to associate |
| | with the logical AP MLD is success or failure. |
| Bit based | An encoding wherein multiple bits are set to a specific value/pattern to |
| encoding | confirm the intent to associate with a logical AP MLD. |
| Implicit | An implicit indication can be made by including or initiation one or more |
| indication | signaling that are related to logical AP MLD operation. e.g., including an |
| | information element that is used for logical AP MLD operation. |
| Logical AP | Information item(s) that can provide more details on the logical AP MLD. |
| MLD | e.g., any information item that can describe the operation parameters that |
| information | need to be set to operate with the logical AP MLD. |
| Security keys | Information item(s) that can provide security keys that are needed for |
| | encryption. |
| Other AP | One or more information item(s) that can indicate the other APs that are a |
| identifiers | part of the logical AP MLD that the STA can seamlessly roam to. e.g., their |
| | MAC address, MLD IDs, IDs, among others. |
| Other AP | One or more information item(s) that can provide more information on the |
| information | logical AP MLD. This information can be related to the transmitting AP |
| | and/or one or more of the other APs of the logical AP MLD. e.g., PHY |
| | capabilities, MAC capabilities, MAC related constraints, near static context |
| | transfer related capabilities, dynamic context transfer related capabilities, |
| | roaming preparation stage related capabilities, roaming setup stage related |
| | capabilities, roaming transition stage related capabilities, among others. |
| Security key | One or more information items that can indicate if security keys setup |
| related | during association can be transferred during roaming or need to be |
| capabilities | rekeyed/renegotiated at the time of roam. |

The above information items can be transmitted together or separately. They can be transmitted as a part of any existing frame/element/field/subfield in the standard or can be a part of newly defined ones.

In some embodiments, during the process of association with the logical AP MLD, the security keys used for encryption can be derived using the parameters of the logical AP MLD.

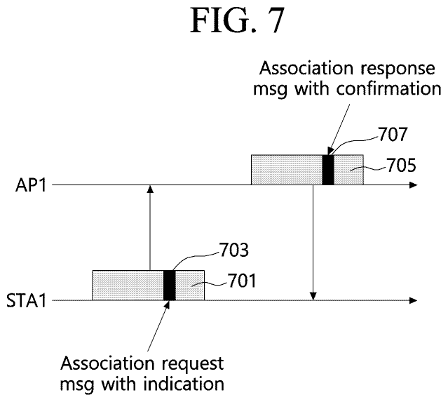

FIG. 7 illustrates an example operation of associating with a logical AP MLD in accordance with an embodiment. In particular, the non-AP MLD intends to associate with the logical AP MLD. STA1 affiliated with non-AP MLD transmits a (Re) association request frame 701 to the AP MLD. The frame 701 includes a flag 703 that can indicate the non-AP MLD's intend to associate with the logical AP MLD. Upon reception of the frame, the AP MLD can interpret the presence of the flag as the intent to associate with the logical AP MLD instead of the physical AP MLD and can respond with a response frame 705 via AP 1 that can include a confirmation 707 of the association with the logical AP MLD.

In some embodiments, upon association, the non-AP MLD can be assigned an AID using the local AID space of the AP MLD. In some embodiments, the AP MLD can use one or more additional indicators to differentiate the AIDs with duplicate AIDs of other AP MLDs that are a part of the logical AP MLD. In certain embodiments, the AIDs can also be unique per AP MLD and change as the non-AP MLD transitions from one AP MLD to another.

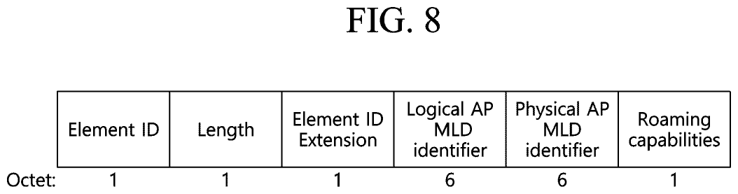

FIG. 8 illustrates an example element format for association with seamless roaming domain in accordance with an embodiment. The element includes an element ID field, a length field, an element ID extension field, a logical AP MLD identifier field, a physical AP MLD identifier field, and a roaming capabilities field. The element ID field may provide an identifier of the element. The length field may provide length information of the element. The element ID extension field may provide extension information of the element. The logical AP MLD identifier field may be a unique identifier to identify the logical AP MLD. For example, an ID or a media access control (MAC) address. The physical AP MLD identifier field may be an identifier that can identify the physical AP MLD that the non-AP will be communicating with after association. For example, the physical AP MLD MAC address. In some embodiments, this address can also be present in the MAC header of the frame that includes the element instead of the element.

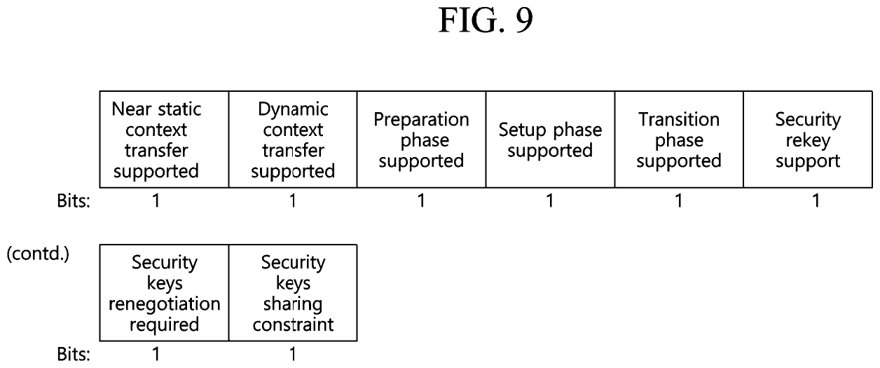

The roaming capabilities field may include information about the capabilities of the non-AP related to seamless roaming. In some embodiments, the roaming capabilities field may also be present in an independent element. The roaming capabilities field can have a format as shown in FIG. 9 in accordance with an embodiment.

FIG. 9 illustrates a roaming capabilities element in accordance with an embodiment. The roaming capabilities element may include a near static context transfer supported field, a dynamic context transfer supported field, a preparation phase supported field, a setup phase supported field, a transition phase supported field, a security rekey support field, a security keys renegotiation required field, and a security keys sharing constraint field.

The near static context transfer supported bit field may indicate if the non-AP or AP can support near static context transfer related procedures. A value of 1 for this bit position can indicate a support and a value of 0 can indicate a lack of such a support.

The dynamic context transfer supported bit field may indicate if the non-AP or AP can support dynamic context transfer related procedures. A value of 1 for this bit position can indicate a support and a value of 0 can indicate a lack of such a support.

The preparation phase supported bit field may indicate if the non-AP or AP can support the preparation phase procedures for seamless roaming. A value of 1 for this bit position can indicate a support and a value of 0 can indicate a lack of such a support.

The setup phase supported bit field can indicate if the non-AP or AP can support the setup phase related procedures for seamless roaming. A value of 1 for this bit position can indicate a support and a value of 0 can indicate a lack of such a support.

The transition phase supported bit filed may indicate if the non-AP or AP can support the transition phase related procedures for seamless roaming. A value of 1 for this bit position can indicate a support and a value of 0 can indicate a lack of such a support.

The security rekeys supported bit field can indicate if the non-AP or AP can support or needs the rekey of security keys when roaming. A value of 1 for this bit position can indicate a support or requirement and a value of 0 can indicate a lack of such a support or requirement.

The security keys negotiation required bit field can indicate if the non-AP or AP can support or needs security keys renegotiation. A value of 1 for this bit position can indicate a support and a value of 0 can indicate a lack of such a support.

The security keys sharing constraint bit field can indicate if the non-AP or AP can support or needs security keys sharing. A value of 1 for this bit position can indicate support and a value of 0 can indicate a lack of such a support. If this bit is set to 1, it can mean that the non-AP or AP is fine with the security keys being shared or transferred during roaming. Otherwise, it can mean that the non-AP or AP can require a rekey or renegotiation of the security keys during roaming.

In some embodiments, the roaming capabilities element can be included in an association request frame that the non-AP MLD transmits to an AP MLD of the logical AP MLD. In certain embodiments, the roaming capabilities element can be included in an association response frame that the non-AP MLD transmits to an AP MLD of the logical AP MLD.

In some embodiments, the non-AP MLD can provide an intent to search for the logical AP MLD during the search phase. The non-AP MLD can make the indication by including at least one or more of the information items as described in Table 1.

In some embodiments, the signaling can be the same or similar as that of the element presented in FIG. 8. The element can be included in probe request frames transmitted by a non-AP MLD to an AP MLD of the logical AP MLD.

In some embodiments, upon receiving the indication, the receiving AP MLD can respond with a confirmation message as in Table 3. In some embodiments, the AP MLD can also include information related to the logical AP MLD that can include one or more of the information items as indicated in Table 4.

TABLE 4

| Information item | Description |
|---|---|
| Operation | An information item that can describe the operation parameters of the |
| information | logical AP MLD. e.g., operation frequency, channel number, bandwidth, |
| | among others. This can be indicated for each affiliated AP MLD. |
| PHY capabilities | An information item that can indicate the PHY capabilities of the logical |
| | AP MLD. |
| MAC | An information item that can indicate the MAC capabilities of the logical |
| capabilities | AP MLD. |
| Affiliated | An information item that can describe the AP MLDs or APs that are |
| collocated | affiliated with the logical AP MLD and are collocated. e.g., MAC |
| APs/AP MLDs | address, BSSID, among others. There can also be an indicator item that |
| | can mark a group of the logical AP MLD's affiliated APs as being |
| | collocated. |
| Affiliated non- | An information item that can describe the AP MLDs or APs that are |
| collocated | affiliated with the logical AP MLD and are non-collocated. e.g., MAC |
| APs/AP MLDs | address, BSSID, among others. There can also be an indicator item that |
| | can mark a group of the logical AP MLD's affiliated APs as being non- |
| | collocated. |

The above information items can be transmitted together or separately. They can be transmitted as a part of any existing frame/element/field/subfield in the standard or can be a part of newly defined ones.

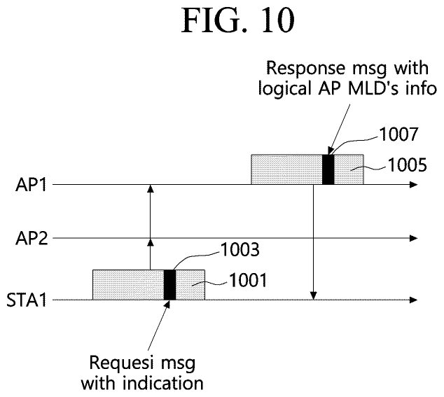

FIG. 10 illustrates an example of associating with a logical AP MLD in accordance with an embodiment. As illustrated, STA1 affiliated with non-AP MLD transmits a probe message 1001 that includes an indication 1003 to associate with a logical AP MLD. AP 1 is affiliated with a logical AP MLD and AP2 is not affiliated with a logical AP MLD. When AP1 receives the probe message 1001 with the indication 1003, it can respond with a response message 1005 whereas AP2 does not respond with a response message. The response message 1007 can include an indication 1007 of the logical AP MLD's information.

In some embodiments, one or more information items of the confirmation message can also be advertised in the beacon by the APs of the logical AP MLD. For example, the element shown in FIG. 8 can be advertised in a beacon by the AP.

In some embodiments, one or more of the security key(s) can be generated during association and can be transferred to a new physical AP MLD when roaming occurs. In certain embodiments, one or more of the security key(s) can be generated each time there is a transition to a new physical AP MLD. The target AP MLD can generate the new security keys and transmit to the non-AP MLD directly or via the current AP MLD.

As described herein, the logical AP MLD may also be referred to by other names, such as non-collocated AP MLD among others.

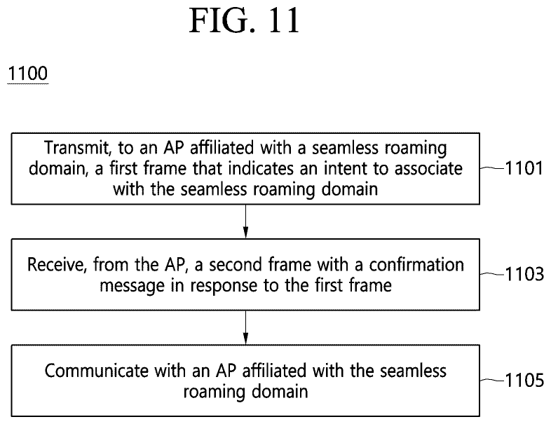

FIG. 11 illustrates a flow chart of an example process performed by an STA of associating with a seamless roaming domain (SRD) in accordance with an embodiment. Although one or more operations are described or shown in particular sequential order, in other embodiments the operations may be rearranged in a different order, which may include performance of multiple operations in at least partially overlapping time periods. The flowchart depicted in FIG. 11 illustrates operations performed in an STA, such as the STA illustrated in FIG. 3.

The process 1100, in operation 1101, the STA, transmits to an AP affiliated with a seamless roaming domain, a first frame that indicates an intent to associate with the SRD. In some embodiments, the first frame can include or more information items set out in Table 1 above.

In operation 1103, the STA receives, from the AP, a second frame that includes a confirmation message in response to the first frame. In some embodiments, the second frame includes one or more information items set out in Table 3 above. When the indication message is received by an AP, the AP can interpret the message as an indicator of the non-AP MLD's intent to associate with the logical AP MLD. Thereafter, if the receiver is the AP MLD, it can enable the non-AP MLD's association with the logical AP MLD if the non-AP MLD has made the indication. If the non-AP MLD has not made such an indication, then the AP MLD can enable the non-AP MLD to associate with the physical AP MLD instead. This can require the non-AP to use baseline roaming procedures or some other roaming enhancement when roaming from one AP MLD to another.

In operation 1105, the STA communicates with an AP affiliated with the seamless roaming domain.

Embodiments in accordance with this disclosure may perform a handover procedure for a non-AP MLD to associate with a logical AP MLD and allow for an STA affiliated with the non-AP MLD to switch from one AP to a different AP without disruption in a connection, providing an improve user experience especially with multimedia services which can suffer from session disruptions due to the high delay encountered during existing handover procedure.

A reference to an element in the singular is not intended to mean one and only one unless specifically so stated, but rather one or more. For example, “a” module may refer to one or more modules. An element proceeded by “a,” “an,” “the,” or “said” does not, without further constraints, preclude the existence of additional same elements.

Headings and subheadings, if any, are used for convenience only and do not limit the invention. The word exemplary is used to mean serving as an example or illustration. To the extent that the term “include,” “have,” or the like is used, such term is intended to be inclusive in a manner similar to the term “comprise” as “comprise” is interpreted when employed as a transitional word in a claim. Relational terms such as first and second and the like may be used to distinguish one entity or action from another without necessarily requiring or implying any actual such relationship or order between such entities or actions.

Phrases such as an aspect, the aspect, another aspect, some aspects, one or more aspects, an implementation, the implementation, another implementation, some implementations, one or more implementations, an embodiment, the embodiment, another embodiment, some embodiments, one or more embodiments, a configuration, the configuration, another configuration, some configurations, one or more configurations, the subject technology, the disclosure, the present disclosure, other variations thereof and alike are for convenience and do not imply that a disclosure relating to such phrase(s) is essential to the subject technology or that such disclosure applies to all configurations of the subject technology. A disclosure relating to such phrase(s) may apply to all configurations, or one or more configurations. A disclosure relating to such phrase(s) may provide one or more examples. A phrase such as an aspect or some aspects may refer to one or more aspects and vice versa, and this applies similarly to other foregoing phrases.

A phrase “at least one of” preceding a series of items, with the terms “and” or “or” to separate any of the items, modifies the list as a whole, rather than each member of the list. The phrase “at least one of” does not require selection of at least one item; rather, the phrase allows a meaning that includes at least one of any one of the items, and/or at least one of any combination of the items, and/or at least one of each of the items. By way of example, each of the phrases “at least one of A, B, and C” or “at least one of A, B, or C” refers to only A, only B, or only C; any combination of A, B, and C; and/or at least one of each of A, B, and C.

It is understood that the specific order or hierarchy of steps, operations, or processes disclosed is an illustration of exemplary approaches. Unless explicitly stated otherwise, it is understood that the specific order or hierarchy of steps, operations, or processes may be performed in different order. Some of the steps, operations, or processes may be performed simultaneously or may be performed as a part of one or more other steps, operations, or processes. The accompanying method claims, if any, present elements of the various steps, operations or processes in a sample order, and are not meant to be limited to the specific order or hierarchy presented. These may be performed in serial, linearly, in parallel or in different order. It should be understood that the described instructions, operations, and systems can generally be integrated together in a single software/hardware product or packaged into multiple software/hardware products.

The disclosure is provided to enable any person skilled in the art to practice the various aspects described herein. In some instances, well-known structures and components are shown in block diagram form in order to avoid obscuring the concepts of the subject technology. The disclosure provides various examples of the subject technology, and the subject technology is not limited to these examples. Various modifications to these aspects will be readily apparent to those skilled in the art, and the principles described herein may be applied to other aspects.

All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. § 112, sixth paragraph, unless the element is expressly recited using a phrase means for or, in the case of a method claim, the element is recited using the phrase step for.

The title, background, brief description of the drawings, abstract, and drawings are hereby incorporated into the disclosure and are provided as illustrative examples of the disclosure, not as restrictive descriptions. It is submitted with the understanding that they will not be used to limit the scope or meaning of the claims. In addition, in the detailed description, it can be seen that the description provides illustrative examples and the various features are grouped together in various implementations for the purpose of streamlining the disclosure. This method of disclosure is not to be interpreted as reflecting an intention that the claimed subject matter requires more features than are expressly recited in each claim. Rather, as the following claims reflect, inventive subject matter lies in less than all features of a single disclosed configuration or operation. The following claims are hereby incorporated into the detailed description, with each claim standing on its own as a separately claimed subject matter.

The claims are not intended to be limited to the aspects described herein, but are to be accorded the full scope consistent with the language claims and to encompass all legal equivalents. Notwithstanding, none of the claims are intended to embrace subject matter that fails to satisfy the requirements of the applicable patent law, nor should they be interpreted in such a way.

What is claimed is:

1. A station (STA) in a wireless network, comprising:
a memory; and
a processor coupled to the memory, the processor configured to:
transmit, to an access point (AP) affiliated with a seamless roaming domain, a first frame that indicates that the STA intends to associate with the seamless roaming domain, wherein the seamless roaming domain includes one or more APs affiliated with the seamless roaming domain that provides seamless roaming; and
receive, from the AP affiliated with the seamless roaming domain, a second frame in response to the first frame that provides a confirmation of association with the seamless roaming domain.

2. The STA of claim 1, wherein the processor is further configured to:
transmit, to one or more APs that includes the AP affiliated with the seamless roaming domain, a third frame that indicates an intent to search for the seamless roaming domain; and
receive, from the AP affiliated with the seamless roaming domain, a fourth frame that includes information associated with the seamless roaming domain.

3. The STA of claim 1, wherein the second frame includes one or more security keys that are needed for encryption and are derived using parameters of the seamless roaming domain.

4. The STA of claim 1, wherein the first frame includes an identifier for a particular AP from the one or more APs affiliated with the seamless roaming domain that the STA intends to communicate with after association.

5. The STA of claim 1, wherein the first frame includes a capability information for seamless roaming.

6. The STA of claim 1, wherein the first frame includes information regarding whether a security key setup during association is transferable between the AP affiliated with the seamless roaming domain to a different AP affiliated with the seamless roaming domain during roaming or that the security key needs to be re-negotiated with the different AP at the time of roam.

7. The STA of claim 1, wherein the second frame includes information on other APs that are a part of the seamless roaming domain that the STA is able to seamlessly roam to.

8. The STA of claim 1, wherein the second frame includes i) information related to operation parameters of the seamless roaming domain, ii) information that describes the physical (PHY) capabilities of the seamless roaming domain, iii) information that describes the media access control (MAC) capabilities of the seamless roaming domain, iv) information that describes one or more APs that are affiliated with the seamless roaming domain and are collocated, or v) information that describes one or more APs that are affiliated with the seamless roaming domain and are non-collocated.

9. The STA of claim 1, wherein the first frame includes an indicator that indicates that the STA intends to associate with the seamless roaming domain rather than a physical AP.

10. An access point (AP) in a wireless network, comprising:
a memory; and
a processor coupled to the memory, the processor configured to:
receive, from a station (STA), a first frame that indicates that the STA intends to associate with a seamless roaming domain with which the AP is affiliated, wherein the seamless roaming domain includes one or more APs affiliated with the seamless roaming domain that provides seamless roaming; and
transmit, to the STA, a second frame in response to the first frame that provides a confirmation of association with the seamless roaming domain.

11. The AP of claim 10, wherein the processor is further configured to:
receive, from the STA, a third frame that indicates an intent to search for the seamless roaming domain; and
transmit, to the STA, a fourth frame that includes information associated with the seamless roaming domain.

12. The AP of claim 10, wherein the second frame includes one or more security keys that are needed for encryption and are derived using parameters of the seamless roaming domain.

13. The AP of claim 10, wherein the first frame includes an identifier for a particular AP from the one or more APs affiliated with the seamless roaming domain that the STA intends to communicate with after association.

14. The AP of claim 10, wherein the first frame includes a capability information for seamless roaming.

15. The AP of claim 10, wherein the first frame includes information regarding whether a security key setup during association is transferable between the AP affiliated with the seamless roaming domain to a different AP affiliated with the seamless roaming domain during roaming or that the security key needs to be re-negotiated with the different AP at the time of roam.

16. The AP of claim 10, wherein the second frame includes information on other APs that are a part of the seamless roaming domain that the STA is able to seamlessly roam to.

17. The AP of claim 10, wherein the second frame includes i) information related to operation parameters of the seamless roaming domain, ii) information that describes the physical (PHY) capabilities of the seamless roaming domain, iii) information that describes the media access control (MAC) capabilities of the seamless roaming domain, iv) information that describes one or more APs that are affiliated with the seamless roaming domain and are collocated, or v) information that describes one or more APs that are affiliated with the seamless roaming domain and are non-collocated.

18. The AP of claim 10, wherein the first frame includes an indicator that indicates that the STA intends to associate with the seamless roaming domain rather than a physical AP.

19. A computer-implemented method for wireless communication by a station (STA) in a wireless network, comprising:
transmitting, to an access point (AP) affiliated with a seamless roaming domain, a first frame that indicates that the STA intends to associate with the seamless roaming domain, wherein the seamless roaming domain includes one or more APs affiliated with the seamless roaming domain that provides seamless roaming; and
receiving, from the AP affiliated with the seamless roaming domain, a second frame in response to the first frame that provides a confirmation of association with the seamless roaming domain.

20. The computer implemented method of claim 19, further comprising:
transmitting, to one or more APs that includes the AP affiliated with the seamless roaming domain, a third frame that indicates an intent to search for the seamless roaming domain; and
receiving, from the AP affiliated with the seamless roaming domain, a fourth frame that includes information associated with the seamless roaming domain.
